(19) United States
(12) Patent Application Publication
(10) Pub. No.: US 2026/0091676 A1
(43) Pub. Date: Apr. 2, 2026

(54) DISPLAY CONTROL DEVICE AND DISPLAY CONTROL METHOD FOR VEHICLE

(71) Applicants: DENSO CORPORATION, Kariya-city (JP); J-QuAD DYNAMICS Inc., Chuo-ku (JP)

(72) Inventors: Daichi YAGI, Kariya-city (JP); Shota IBARA, Kariya-city (JP); Aika USUI, Kariya-city (JP); Yosuke HATTORI, Chuo-ku (JP); Ryu KAMBARA, Chuo-ku (JP); Hirotaka SAKAI, Chuo-ku (JP)

(21) Appl. No.: 19/339,978

(22) Filed: Sep. 25, 2025

(30) Foreign Application Priority Data
Sep. 30, 2024 (JP) 2024-169908

(51) Int. Cl. B60K 35/28; B60W 50/00; B60W 50/14; G06V 20/58

(52) U.S. Cl. CPC B60K 35/28; B60W 50/0097; B60W 50/14; G06V 20/58; B60K 2360/171; B60K 2360/176; B60K 2360/178; B60K 2360/1868; B60W 2050/146; B60W 2420/403; B60W 2540/215; B60W 2554/4041; B60W 2554/4045; B60W 2554/80

(57) ABSTRACT

A vehicle display is controlled by detecting an obstacle around the vehicle based on a sensing result of a surrounding monitoring sensor that is configured to monitor a surrounding area of the vehicle, predicting a trajectory of the vehicle, generating a bird's-eye view image which shows the vehicle and the surrounding area of the vehicle from above, using a captured image of a surrounding monitoring camera that is configured to capture the surrounding area of the vehicle, displaying at least a part of the generated bird's-eye view image on a screen of a display device, and offsetting a range of the bird's-eye view image to be displayed on the screen such that a displayed range of the surrounding area with respect to the vehicle changes according to the predicted trajectory and a position of the obstacle.

### CROSS REFERENCE TO RELATED APPLICATION

The present application claims the benefit of priority from Japanese Patent Application No. 2024-169908 filed on Sep. 30, 2024. The entire disclosure of the above application is incorporated herein by reference.

### TECHNICAL FIELD

The present disclosure relates to a display control device and a display control method for a vehicle.

### BACKGROUND ART

There is a technique for displaying a bird's-eye view image of the area surrounding a vehicle from above.

### SUMMARY

According to an aspect of the present disclosure, a display control device to be used in a vehicle includes a controller including at least one of (i) a circuit and (ii) a processor with a memory storing computer program code executable by the processor. The at least one of the circuit and the processor may be configured to cause the display control device to detect an obstacle around the vehicle based on a sensing result of a surrounding monitoring sensor that is configured to monitor a surrounding area of the vehicle, predict a trajectory of the vehicle, generate a bird's-eye view image which shows the vehicle and the surrounding area of the vehicle from above, using a captured image from a surrounding monitoring camera that is configured to capture the surrounding area of the vehicle, display at least a part of the generated bird's-eye view image on a screen of a display device, and offset a range of the bird's-eye view image to be displayed on the screen such that a displayed range of the surrounding area with respect to the vehicle changes according to the predicted trajectory and a position of the obstacle.

### BRIEF DESCRIPTION OF DRAWINGS

FIG. 1 is a diagram showing an example of a schematic configuration of a vehicle system.

FIG. 2 is a diagram for explaining an example in which the configuration of the present embodiment is not applied.

FIG. 3 is a diagram for explaining an example in which the configuration of the present embodiment is applied.

FIG. 4 is a diagram for explaining an example in which the configuration of the present embodiment is applied.

FIG. 5 is a flowchart showing an example of the flow of bird's-eye view image display processing in an image generation ECU.

### DESCRIPTION OF EMBODIMENTS

To begin with, examples of relevant techniques will be described.

A technique is known for displaying a bird's-eye view image of the area surrounding a vehicle from above. For example, there is a technique in which, when the vehicle shifts from moving forward to moving backward, the display area of the bird's-eye view image is expanded rearward relative to the image of the vehicle. The determination of the forward or reverse state is performed based on the shift position. In addition, there is also a technique for trimming the range of the bird's-eye view image displayed on a monitor device so that the displayed bird's-eye view image includes a larger search area. The search area is a region on a surrounding image that is set as an area likely to be in close proximity to a three-dimensional object.

The driver of the vehicle needs to check the vicinity of the predicted path of the vehicle. However, neither of the technologies described above takes the predicted path of the vehicle into consideration. Thus, when the display area of the bird's-eye view image is changed, there is a risk that the area the driver needs to check may become invisible or difficult to see.

The present disclosure provides a display control device and a display control method that make it easier for the driver to check the area they needs to confirm, even when the display area of the bird's-eye view image is changed.

To achieve the above object, a display control device to be used in a vehicle according to the present disclosure includes an obstacle detecting unit, a predicted trajectory specifying unit, a bird's-eye view image generating unit, and a display control unit. The obstacle detecting unit is configured to detect an obstacle around the vehicle based on a sensing result of a surrounding monitoring sensor that is configured to monitor a surrounding area of the vehicle. The predicted trajectory specifying unit is configured to predict a trajectory of the vehicle. The bird's-eye view image generating unit is configured to generate a bird's-eye view image which shows the vehicle and the surrounding area of the vehicle from above, using a captured image of a surrounding monitoring camera that is configured to capture the surrounding area of the vehicle. The display control unit is configured to display at least a part of the bird's-eye view image generated by the bird's-eye view image generating unit on a screen of a display device, and offset a range of the bird's-eye view image to be displayed on the screen such that a displayed range of the surrounding area with respect to the vehicle changes according to the predicted trajectory and a position of the obstacle.

To achieve the above object, a vehicle display control method performed by at least one of a circuit or a processor is provided. The vehicle display control method includes detecting an obstacle around the vehicle based on a sensing result of a surrounding monitoring sensor that is configured to monitor a surrounding area of the vehicle, predicting a trajectory of the vehicle, generating a bird's-eye view image which shows the vehicle and the surrounding area of the vehicle from above, using a captured image of a surrounding monitoring camera that is configured to capture the surrounding area of the vehicle, and displaying at least a part of the generated bird's-eye view image on a screen of a display device. The displaying of the at least a part of the bird's-eye view image includes offsetting a range of the bird's-eye view image to be displayed on the screen such that a displayed range of the surrounding area with respect to the vehicle is changed according to the predicted trajectory and a position of the obstacle.

According to the above configuration, the displayed range of the surrounding area relative to the position of the vehicle on the screen, as a bird's-eye view image, is changed in accordance with the predicted trajectory of the vehicle and the position of an obstacle detected around the vehicle. Thus, the driver can easily confirm the range around the vehicle according to the predicted trajectory and the position of an obstacle. As a result, even when the display area of the bird's-eye view image is changed, the driver can easily check the area according to the predicted trajectory and the position of an obstacle.

Multiple embodiments for disclosure will be described with reference to the drawings. For convenience of explanation, parts having the same functions as those shown in the drawings used in the previous description among the plurality of embodiments may be denoted by the same reference numerals, and their descriptions may be omitted. For parts denoted by the same reference numerals, the descriptions in other embodiments may be referred to.

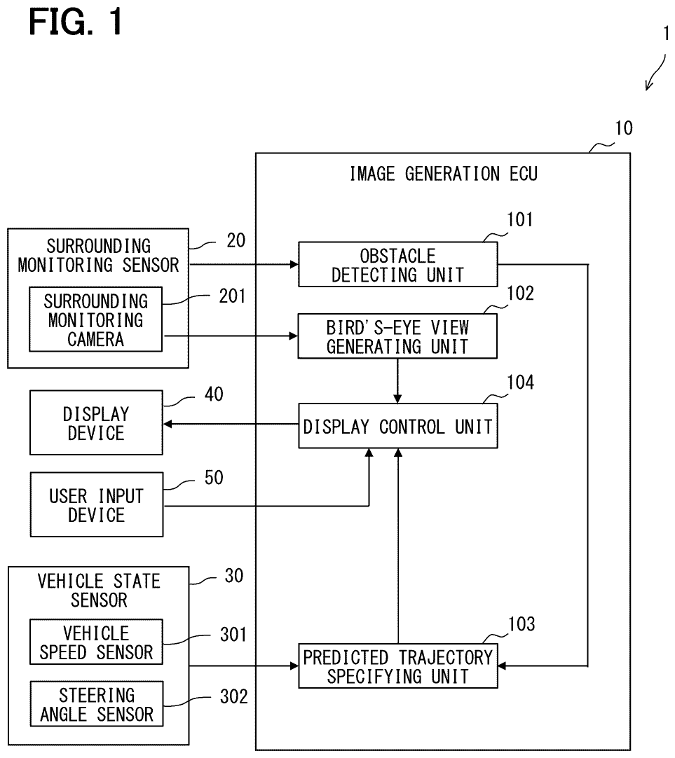

(First Embodiment)<Outline Configuration of Vehicle System 1>Hereinafter, a first embodiment of the present disclosure will be described with reference to the drawings. A vehicle system 1 shown in FIG. 1 is used in a vehicle. As shown in FIG. 1, the vehicle system 1 includes an image generation ECU 10, a surrounding monitoring sensor 20, a vehicle state sensor 30, a display device 40, and a user input device 50.

The surrounding monitoring sensor 20 monitors a surrounding area of the vehicle. In other words, the surrounding monitoring sensor 20 monitors the surrounding environment of the vehicle. The surrounding monitoring sensor 20 includes a surrounding monitoring camera 201. The surrounding monitoring camera 201 captures images of the surrounding area of the vehicle. The surrounding monitoring camera 201 may include multiple cameras for imaging the entire periphery of the vehicle. For example, the surrounding monitoring camera 201 may include a front camera, a rear camera, a left camera, and a right camera. The front camera may capture a predetermined range in front of the vehicle. The rear camera may capture a predetermined range behind the vehicle. The left camera may capture a predetermined range on the left side of the vehicle. The right camera may capture a predetermined range on the right side of the vehicle. The surrounding monitoring camera 201 sequentially outputs captured images of the entire periphery of the vehicle, which are sequentially captured, to the image generation ECU 10 as sensing results.

The surrounding monitoring sensor 20 may include a probe wave sensor that transmits probe waves within a predetermined range around the vehicle. Examples of probe wave sensors include millimeter wave radar, sonar, and LIDAR (Light Detection and Ranging/Laser Imaging Detection and Ranging). The predetermined range includes at least a portion of the front, rear, left, and right sides of the vehicle. The probe wave sensor sequentially outputs scan results, which are based on received signals obtained when reflected waves are received from obstacles, to the image generation ECU 10 as sensing results. The surrounding monitoring sensor 20 may output the sensing results to the image generation ECU 10 via an in-vehicle LAN by outputting the sensing results to the in-vehicle LAN.

The vehicle state sensor 30 is a group of sensors for detecting various states of the vehicle. The vehicle state sensor 30 includes a vehicle speed sensor 301 and a steering angle sensor 302. The vehicle speed sensor 301 detects the speed of the vehicle. The steering angle sensor 302 detects the steering angle of the vehicle. The vehicle state sensor 30 sequentially outputs the detected sensing results to the image generation ECU 10. The vehicle state sensor 30 may output the sensing results to the image generation ECU 10 through the in-vehicle LAN by outputting the sensing results to the in-vehicle LAN.

The display device 40 displays images according to instructions from the image generation ECU 10. The display device 40 may be a meter MID (Multi Information Display), CID (Center Information Display), or HUD (Head-Up Display). The meter MID is provided in front of the driver seat in the vehicle interior. As one example, the meter MID may be provided on the meter panel. The CID is arranged at the center of the instrument panel of the vehicle. The HUD may be provided on the instrument panel in the vehicle interior. The HUD projects a display image formed by a projector onto a predetermined projection area of the front windshield, which serves as a projection member. Light from the image reflected toward the vehicle interior by the front windshield is perceived by the driver seated in the driver seat. As a result, the driver can visually recognize the virtual image of the display image, which is formed in front of the front windshield, superimposed on part of the foreground. The HUD may also be configured to project the display image onto a combiner provided in front of the driver seat, instead of the front windshield. The display device 40 may be a CID.

The user input device 50 receives input from occupants of the vehicle. The user input device 50 may be an operation device that receives operation input from an occupant. The operation device may be a mechanical switch or a touch switch integrated with the display. Examples of mechanical switches include steering switches provided on a steering wheel. It should be noted that the user input device 50 is not limited to an operation device that receives operation input, as long as it is a device that receives input from an occupant. For example, it may be a voice input device that receives command inputs from the occupant via voice.

The image generation ECU 10 is mainly formed of a computer including, for example, a processor, volatile memory, non-volatile memory, I/O, and a bus connecting these components. The image generation ECU 10 includes a controller and executes various processes related to image display by executing a control program stored in the non-volatile memory. The image generation ECU 10 corresponds to a display control device. It should be noted that at least a part of the functions performed by the processor in the image generation ECU 10 may be carried out by circuitry. The term “circuitry” as used here refers to hardware circuits. The configuration of the image generation ECU 10 will be described in detail below.

<Schematic Configuration of Image Generation ECU 10>Next, the schematic configuration of the image generation ECU 10 will be explained with reference to FIG. 1. As shown in FIG. 1, the image generation ECU 10 includes, as functional blocks, an obstacle detecting unit 101, a bird's-eye view image generating unit 102, a predicted trajectory specifying unit 103, and a display control unit 104. In addition, executing the processing of each functional block of the image generation ECU 10 with a computer corresponds to executing a display control method. It should be noted that some or all of the functions executed by the image generation ECU 10 may be implemented in hardware by one or more circuits or the like. Furthermore, some or all of the functional blocks included in the image generation ECU 10 may be implemented by a combination of software executed by a processor and hardware circuits.

The obstacle detecting unit 101 detects an obstacle around the vehicle based on the sensing results from the surrounding monitoring sensor 20. The processing performed by the obstacle detecting unit 101 corresponds to an obstacle detection step. Examples of obstacles include moving objects such as pedestrians and other vehicles. Examples of obstacles also include stationary objects such as fallen objects on the road and installations on the roadside. The obstacle detecting unit 101 is configured to detect obstacles, including the positions of the obstacles relative to the vehicle. In cases where the obstacle detecting unit 101 detects the position of an obstacle using the sensing results from a probe wave sensor, the following procedure may be used. The obstacle detecting unit 101 may detect the direction of the obstacle relative to the vehicle based on the direction in which the probe wave, whose reflected wave is received from the obstacle, was transmitted. The obstacle detecting unit 101 may detect the distance from the vehicle to the obstacle based on the time it takes for the probe wave to be reflected by the obstacle and return to the vehicle. The obstacle detecting unit 101 may detect the position of the obstacle relative to the vehicle based on the detected direction and distance.

The obstacle detecting unit 101 may detect the presence of an obstacle and its position using an image captured by the surrounding monitoring camera 201. In this case, the following procedure may be used. The obstacle detecting unit 101 may detect an obstacle from the captured image using image recognition technology. The obstacle detecting unit 101 may detect the position of the obstacle relative to the vehicle based on the position of the obstacle in the captured image and the camera parameters of the surrounding monitoring camera 201 from which the captured image was obtained. For example, the position of the obstacle may be detected as a position on a coordinate system based on the position of the vehicle. The position of the vehicle may be sequentially identified based on the positioning results from a locator of the vehicle. The camera parameters may be the installation position and the orientation of the optical axis of the surrounding monitoring camera 201 on the vehicle.

The locator may be equipped with a GNSS (Global Navigation Satellite System) receiver and an inertial sensor. The GNSS receiver receives positioning signals from multiple positioning satellites. The inertial sensor may include a gyroscope and an accelerometer. The locator sequentially determines the position of the vehicle by combining the positioning signals received by the GNSS receiver with the measurement results from the inertial sensor. The position of the vehicle may be represented by latitude and longitude coordinates. Alternatively, the position of the vehicle may be represented as coordinates on a vehicle coordinate system in which a predetermined reference point of the vehicle at a certain time is defined as the origin. In this case, the locator may determine the coordinates on the vehicle coordinate system based on the measurement results from the inertial sensor.

The bird's-eye view image generating unit 102 generates a bird's-eye view image, which shows the vehicle and the surrounding area as viewed from above, by using captured images taken by the surrounding monitoring camera 201. The processing performed by the bird's-eye view image generating unit 102 corresponds to a bird's-eye view image generation step. The bird's-eye view image generating unit 102 may generate the bird's-eye view image as follows. Here, as an example, a case will be described in which captured images captured the front camera, the rear camera, the left camera, and the right camera are used. The bird's-eye view image generating unit 102 converts each captured image from the front camera, rear camera, left camera, and right camera into image data in a ground surface coordinate system, which is a coordinate system on the road surface, using coordinate transformation equations. The image data represents a virtual viewpoint above the vehicle. For example, the images are converted into a bird's-eye view image looking vertically down onto the ground surface. Next, the bird's-eye view image generating unit 102 rotates and translates each bird's-eye image from the front camera, rear camera, left camera, and right camera using transformation equations, and arranges them on a single coordinate plane. In other words, the bird's-eye images are positioned so that they form a single image. Then, the bird's-eye view image generating unit 102 synthesizes these bird's-eye view images into a composite, and uses the composite image as the bird's-eye view image of the surrounding area of the vehicle.

It should be noted that the bird's-eye view image generating unit 102 may be configured to perform necessary image processing such as lens distortion correction on the captured images before converting them into bird's-eye view images. Additionally, when generating the composite image, the bird's-eye view image generating unit 102 places an image of the vehicle at the position corresponding to the vehicle's location and synthesizes the image of the vehicle into the bird's-eye view image. The image of the vehicle may be read out from the memory of the image generation ECU 10, where the image of the vehicle has been stored in advance.

The position of the vehicle in the composite image may be specified based on the portion of the vehicle included in the captured image, in cases where a part of the vehicle is present in the captured image. It should be noted that even if no part of the vehicle is included in the captured image, it is still possible to specify the position of the vehicle in the composite image. Details are as follows. Once the installation position and the orientation of the optical axis of the surrounding monitoring camera 201 relative to the vehicle are determined, the correspondence between positions in the captured image and the installation position of the surrounding monitoring camera 201 can be specified. Thus, based on the installation position and the orientation of the optical axis of the surrounding monitoring camera 201 relative to the vehicle, the position of the surrounding monitoring camera 201 corresponding to a position in the composite image can also be specified. In addition, from the installation position of the surrounding monitoring camera 201 relative to the vehicle, the position of the vehicle relative to the installation position of the surrounding monitoring camera 201 can be specified. Thus, from the position of the surrounding monitoring camera 201 corresponding to a position in the composite image, the position of the vehicle in the composite image can also be specified.

The predicted trajectory specifying unit 103 specifies the predicted trajectory of the vehicle. The processing performed by the predicted trajectory specifying unit 103 corresponds to a predicted trajectory specifying step. The predicted trajectory specifying unit 103 may specify the predicted trajectory of the vehicle based on the vehicle speed, steering angle, and vehicle information of the vehicle. The vehicle speed of the vehicle may be obtained from the vehicle speed sensor 301. The steering angle of the vehicle may be obtained from the steering angle sensor 302. As vehicle information, parameters such as the steering gear ratio and vehicle width may be used. The steering gear ratio is a gear ratio of the tire turning angle relative to the steering angle. The vehicle information may be obtained from the memory of the image generation ECU 10 storing vehicle information in advance. The predicted trajectory specifying unit 103 may determine the turning angle based on the steering angle and the steering gear ratio. Then, the predicted trajectory specifying unit 103 may predict the position of the vehicle at each predetermined time point based on the determined turning angle and the vehicle speed, and predict the trajectory from the group of predicted positions. The predicted trajectory may be a line extending from the center of the vehicle width, or an extension of the vehicle width in the traveling direction. The predicted trajectory specifying unit 103 may predict the trajectory up to the predicted position of the vehicle after a predetermined period. The predetermined period may be set arbitrarily, for example, to three seconds.

The predicted trajectory specifying unit 103 may be configured not to predict the trajectory when the vehicle is stopped and there is no shift change to the forward position “D” or the reverse position “R”. On the other hand, the predicted trajectory specifying unit 103 may predict the trajectory based on a shift change to the forward position “D” or the reverse position “R”, even when the vehicle is stopped. In this case, the trajectory may be predicted by assuming that the vehicle speed is a predetermined speed. The predetermined speed may be set arbitrarily, and may be a creeping speed such as 10 km/h. Thus, it becomes possible to predict the trajectory even while the vehicle is stopped, in cases where there is a high possibility that the vehicle will start moving. Accordingly, an offset processing, which will be described later, can be performed when there is a high possibility that the vehicle will start moving, even while the vehicle is stopped.

The display control unit 104 causes the display device 40 to display the bird's-eye view image generated by the bird's-eye view image generating unit 102 on a screen of the display device 40. The size of the bird's-eye view image generated by the bird's-eye view image generating unit 102 is larger than the size of the image displayed on the screen of the display device 40. The display control unit 104 may perform trimming to extract a part of the bird's-eye view image generated by the bird's-eye view image generating unit 102, and display the trimmed bird's-eye view image on the screen. In the trimming process, an image of a size suitable for display on the screen is extracted from the bird's-eye view image generated by the bird's-eye view image generating unit 102. By default, the display control unit 104 may perform trimming so that the position of the vehicle included in the bird's-eye view image is located at the center of the screen.

The display control unit 104 may display the bird's-eye view image on the screen of the display device 40, using any of the following as a trigger to start the display. The trigger may be receiving an instruction input via the user input device 50 to turn on the bird's-eye view image display function (hereinafter referred to as a bird's-eye view function ON input). The trigger may be starting a vehicle function that involves displaying a bird's-eye view image on the screen of the display device 40. An example of such a vehicle function is an automatic parking function that automatically parks the vehicle. In the following, an example will be described in which the function for displaying the bird's-eye view image is turned on when the automatic parking function is activated.

The display control unit 104 changes the range of the surrounding area, relative to the position of the vehicle, to be displayed as a bird's-eye view image on the screen, according to the predicted trajectory specified by the predicted trajectory specifying unit 103 and the position of an obstacles detected by the obstacle detecting unit 101. Hereinafter, the range of the surrounding area relative to the position of the vehicle to be displayed as a bird's-eye view image on the screen will be referred to as a “displayed range.” The display control unit 104 changes the displayed range by offsetting the position set as the center of the screen in the trimming process from the position of the vehicle included in the bird's-eye view image. The change in the displayed range can also be described as a change in the positional relationship between the position of the vehicle in the bird's-eye view image and the center position of the displayed bird's-eye view image. Hereinafter, the process of changing the displayed range according to the predicted trajectory specified by the predicted trajectory specifying unit 103 and the positions of an obstacle detected by the obstacle detecting unit 101 will be referred to as an offset processing. It should be noted that the processing performed by the display control unit 104 corresponds to a display control step.

According to the above configuration, the displayed range is changed in accordance with the predicted trajectory of the vehicle and the position of an obstacle detected around the vehicle. Thus, it is possible to change the displayed range so that the area to be checked by the driver in accordance with the predicted trajectory and the position of an obstacle can be more easily confirmed. As a result, even when the displayed area of the bird's-eye view image is changed, the driver can easily check the area according to the predicted trajectory and the position of an obstacle.

The display control unit 104 may offset the displayed range in the direction in which the predicted trajectory, specified by the predicted trajectory specifying unit 103, is oriented (a forward direction). In other words, the displayed range of the surrounding area to be displayed as a bird's-eye view image on the display screen may be changed so that the area around the direction in which the predicted trajectory is oriented, relative to the position of the vehicle, is displayed more widely on the screen. In addition, when an obstacle detected by the obstacle detecting unit 101 is located within a predetermined distance from the predicted trajectory, the display control unit 104 may reduce the amount of change in the displayed range in the direction of the predicted trajectory, as compared to when the obstacle is not located within the predetermined distance from the predicted trajectory. The predetermined distance may be set arbitrarily. For example, the predicted trajectory may be defined as an extension of the vehicle width in the travelling direction.

It is considered that the driver of the vehicle has a particular need to check the direction in which the predicted trajectory of the vehicle is oriented. The above configuration enables a wider area of the surrounding area in the direction of the predicted trajectory of the vehicle to be displayed on the display screen. Thus, even when the displayed area of the bird's-eye view image is changed, the driver of the vehicle can easily check the area the driver wants to confirm. In addition, when an obstacle is detected near the predicted trajectory, it is considered that the driver of the vehicle has a greater need to check the obstacle than to check the area ahead of the predicted trajectory. The above configuration keeps the amount of change in the displayed area in the direction of the predicted trajectory small when an obstacle is detected near the predicted trajectory. Thus, it is possible to suppress changing the displayed area to a range that the driver does not desire.

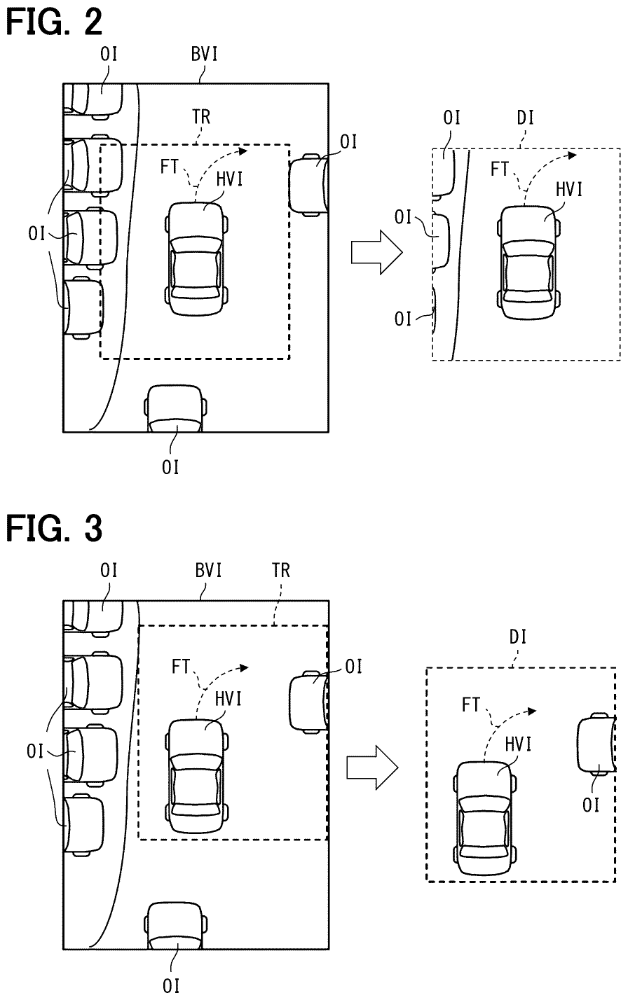

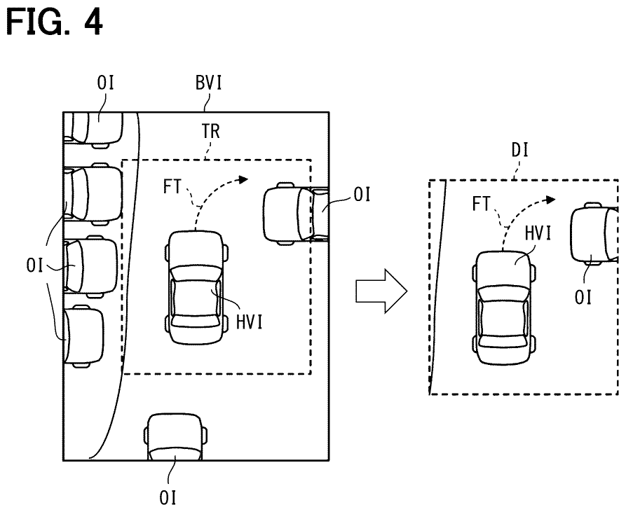

Here, an example of changes in the displayed area according to the predicted trajectory of the vehicle and the position of an obstacle detected around the vehicle will be described with reference to FIGS. 2 to 4. FIG. 2 is a diagram for explaining an example in which the configuration of the present embodiment is not applied. FIGS. 3 and 4 are diagrams for explaining examples in which the configuration of the present embodiment is applied. FIG. 3 is a diagram showing an example in which no obstacle is detected within a set distance from the predicted trajectory of the vehicle. FIG. 4 is a diagram showing an example in which an obstacle is detected within a set distance from the predicted trajectory of the vehicle. The BVI in FIGS. 2 to 4 indicates the bird's-eye view image generated by the bird's-eye view image generating unit 102. The DI in FIGS. 2 to 4 indicates an image (hereinafter referred to as a displayed image) that is trimmed from the bird's-eye view image (BVI) and displayed on the display screen. TR in FIGS. 2 to 4 indicates the region to be trimmed. HVI in FIGS. 2 to 4 indicates an image of the vehicle, and OI indicates an image of an obstacle. FT in FIGS. 2 to 4 indicates the predicted trajectory of the vehicle. The predicted trajectory FT does not necessarily have to be displayed on the display screen. The predicted trajectory FT may be displayed in a linear form, or in a band form having a width corresponding to the vehicle width.

When the configuration of the present embodiment is not applied, the displayed range is as follows. The displayed images DI in FIGS. 2 to 4 correspond to the displayed range. In the example shown in FIG. 2, trimming is performed so that the position of the vehicle image HVI in the bird's-eye view image BVI is located at the center of the displayed image DI. Then, the displayed image DI extracted by trimming is displayed on the display screen. The displayed image DI shown in FIG. 2 does not include the area ahead of the predicted trajectory of the vehicle, making it difficult to grasp the situation ahead along the predicted trajectory.

When the configuration of the present embodiment is applied, the displayed range is as follows. In the examples shown in FIGS. 3 and 4, trimming is performed such that the position of the vehicle image HVI in the bird's-eye view image BVI is offset from the center of the displayed image DI in the direction opposite to the direction in which the predicted trajectory FT of the vehicle is heading. In other words, trimming is performed so that a larger portion of the surrounding area in the direction of the predicted trajectory FT, as viewed from the vehicle image HVI, is included in the displayed range. Then, the displayed image DI extracted by trimming is displayed on the display screen. The displayed images DI shown in FIGS. 3 and 4 include a larger area ahead of the predicted trajectory of the vehicle compared to the case in FIG. 2, making it easier to grasp the situation ahead of the predicted trajectory.

Further, as can be seen from a comparison between FIGS. 3 and 4, when an obstacle is detected within a set distance from the predicted trajectory of the vehicle, the above-mentioned offset amount is kept smaller than when no obstacle is detected within the set distance from the predicted trajectory. In other words, in the case of FIG. 4, trimming is performed to reduce the amount of the surrounding area in the direction of the predicted trajectory FT included in the display image, as viewed from the vehicle image HVI, compared to the case of FIG. 3. This prevents the displayed range from being extended to include an area along the predicted trajectory FT beyond the range desired by the driver, when an obstacle is detected near the predicted trajectory FT.

The display control unit 104 may switch execution or non-execution of the offset processing in accordance with an input for selecting whether to perform the offset processing, which is received via the user input device 50. This allows the user to select whether to change the displayed range by the offset processing according to their preference. Hereinafter, the input for selecting whether to perform the offset processing will be referred to as an “offset selection input.”

The display control unit 104 may superimpose an image indicating the predicted trajectory, which is specified by the predicted trajectory specifying unit 103, on the bird's-eye view image. This makes it easier for the driver of the vehicle to understand the range that the driver should check.

The display control unit 104 may switch whether to display the image indicating the predicted trajectory based on a selection input, received via the user input device 50. This allows the user to select whether to display an image showing the predicted trajectory, depending on the user's preference. Hereinafter, the selection input for selecting whether to display the image indicating the predicted trajectory will be referred to as a “trajectory display selection input.”

The display control unit 104 may change the displayed area so that the displayed range of the bird's-eye view image includes at least a part of the vehicle. In other words, the displayed area may be changed so that at least a part of the image of the vehicle is shown on the display screen of the display device 40. This allows the occupants of the vehicle to always gauge distances based on the image of the vehicle, even when the displayed range is changed. Thus, even when the displayed area is changed, it is less likely for the occupants of the vehicle to lose their sense of distance in the bird's-eye view image.

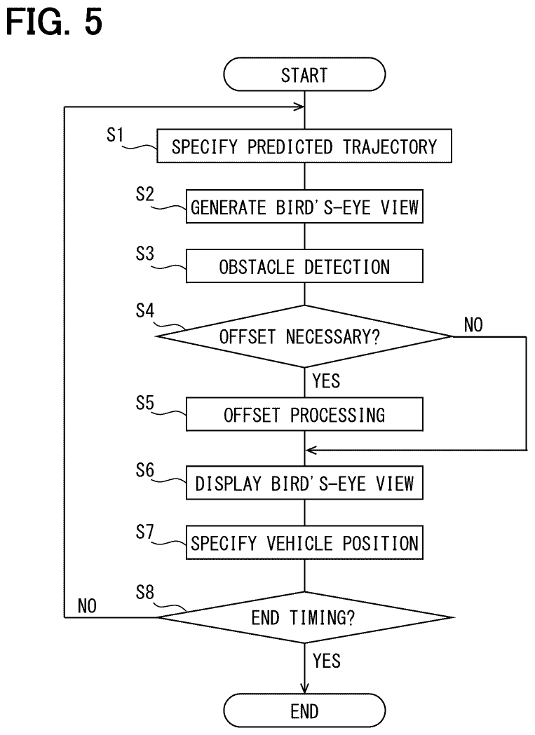

The display control unit 104 may be configured to change the displayed area as described below, according to the predicted trajectory of the vehicle and the position of an obstacle detected around the vehicle. The display control unit 104 may change the displayed area to include the region corresponding to the predicted trajectory specified by the predicted trajectory specifying unit 103 and any obstacles detected by the obstacle detecting unit 101 that are located within a set distance from that region. According to this, it is possible to change the displayed area in accordance with a change in the predicted trajectory or in obstacles near the predicted trajectory. It is considered that there is a need for the driver of the vehicle to check the region corresponding to the predicted trajectory and an obstacle near that region. Thus, the above configuration also enables to the driver to check the desired area even when the displayed area of the bird's-eye view image changes.

<Bird's-Eye View Image Display Processing in Image Generation ECU 10>Here, with reference to the flowchart in FIG. 5, an example of the flow of processing related to the display of the bird's-eye view image (hereinafter referred to as “bird's-eye view image display processing”) in the image generation ECU 10 will be described. The flowchart in FIG. 5 may be started when the above-mentioned bird's-eye view function ON input is received by the user input device 50. Alternatively, the process may start when the automatic parking function is activated.

First, in step S1, the predicted trajectory specifying unit 103 specifies the predicted trajectory. The predicted trajectory specifying unit 103 may be configured not to specify a predicted trajectory when the vehicle is stopped and there is no shift to the drive position “D” or the reverse position “R”.

In step S2, the bird's-eye view image generating unit 102 acquires captured images taken by the surrounding monitoring camera 201 and generates a bird's-eye view image. As a specific example, the system acquires captured images from the front camera, rear camera, left camera, and right camera, and generates a bird's-eye view image so that these can be regarded as a single image. In the bird's-eye view image, an image of the vehicle is superimposed at the position corresponding to the vehicle. In step S3, the obstacle detecting unit 101 detects an obstacle around the vehicle based on the sensing results from the surrounding monitoring sensors 20.

In step S4, the display control unit 104 determines whether offset processing is necessary. The display control unit 104 may determine the necessity of offset processing in accordance with the offset selection input received via the user input device 50. Additionally, the display control unit 104 may determine that offset processing is unnecessary when the vehicle is stationary and there is no shift to the drive position “D” or the reverse position “R.” In step S4, when it is determined that offset processing is necessary (YES in S4), the process proceeds to step S5. On the other hand, when it is determined that offset processing is unnecessary (NO in S4), the process proceeds to step S6.

In step S5, the display control unit 104 performs the offset processing based on the predicted trajectory identified in S1 and the position of the obstacle detected in S3. In step S6, the display control unit 104 causes the display device 40 to display at least a part of the bird's-eye view image on the display screen. In S6, when the offset processing has been performed in S5, the bird's eye view image having subjected to the offset processing is displayed. In S6, when the offset processing has not been performed in S5, the bird's eye view image without the offset processing is displayed. In S6, the display control unit 104 may cause an image indicating the predicted trajectory to be superimposed on the bird's-eye view image. In S6, the display control unit 104 may switch whether to superimpose the image indicating the predicted trajectory on the bird's-eye view image according to the trajectory display selection input received via the user input device 50.

In step S7, the image generation ECU 10 identifies the position of the vehicle based on the positioning results from the locator in the vehicle. The position of the vehicle may be used in an automatic parking function to determine whether the vehicle has reached the target parking position. When it is a timing for ending the bird's-eye view image display processing (YES in S8), the bird's-eye view image display processing is ended. On the other hand, when it is not a timing for ending the bird's-eye view image display processing (NO in S8), the process returns to S1 and is repeated. An example of the timing for ending the bird's-eye view image display processing is when an instruction to turn off the bird's-eye view image display function is received via the user input device 50. Additionally, when the start of the automatic parking function serves as the trigger for initiating the flowchart in FIG. 5, the completion of automatic parking is also an example of the timing for ending the process. Other examples include turning off the power switch or the like. The power switch is a switch used to start the vehicle's internal combustion engine or motor generator.

(Second Embodiment) In the first Embodiment, the image generation ECU 10 was described as corresponding to the vehicle display control device. However, the present disclosure is not limited to this configuration. For example, an ECU other than the image generation ECU 10 may be configured to correspond to the display control device.

In the present disclosure or the claims, the term “processor” may refer to a single hardware processor or several hardware processors that are configured to execute processing defined by computer program code (i.e., one or more instructions of a computer program) by sequentially reading the computer program code included in a computer program. In other words, a “processor” is a hardware device that executes one or more program processes. Therefore, the computer program code can be considered software that defines the processing of the processor according to its content. The “processor” may be a general-purpose or specific-purpose processor, such as, CPU (Central Processing Unit), a microprocessor, GPU (Graphics Processing Unit) and DFP (Data Flow Processor), but is not limited to these examples.

In the present disclosure or the claims, the term “memory” is a non-transitory tangible storage medium and may refer to a single or several hardware memories configured to store computer program code and/or data in a manner accessible by the processor. The “memory” may be implemented using any suitable memory technology, such as SRAM (Static Random-access Memory), SDRAM (Synchronous Dynamic RAM), nonvolatile/flash memory, or other types of memory. The computer program code that constitutes the program is stored on the memory and, when executed by a processor, causes the processor to realize the various functions described above.

In the present disclosure or the claims, the term “circuit” refers to a single hardware logic circuit or several hardware logic circuits (in other words, “circuitry”) that are configured to execute specific processing defined based on a pre-designed circuit configuration. In other words (and in contrast to the “processor”), the term “circuit” in the present disclosure or the claims refers to a hardware device that executes specific processing based on a circuit configuration, not processing defined by software such as the above-described computer program code. For instance, “circuit” may include a custom IC (Integrated Circuit) such as ASIC (Application Specific Integrated Circuit) or FPGA (Field Programmable Gate Array) designed using a hardware description language (HDL). That is, the term “circuit” in the present disclosure or the claims includes all hardware circuits except the above-described processor that executes processing by reading computer program code.

In the present disclosure or claims, the phrase “at least one of a processor and a circuit” should be interpreted in a disjunctive (logical OR) sense, and should not be interpreted as requiring at least one processor and at least one circuit. Accordingly, in the present disclosure or claims, “at least one of a processor and a circuit” includes cases where all functions are performed solely by the circuit. Additionally, in the present disclosure or claims, “at least one of a processor and a circuit” includes cases where all functions are performed solely by the processor. In the present disclosure or claims, “at least one of a processor and a circuit” includes cases where the circuit performs some of the functions and the processor performs the remaining functions.

1. A display control device to be used in a vehicle, the display control device comprising:
a controller including at least one of (i) a circuit and (ii) a processor with a memory storing computer program code executable by the processor, the at least one of the circuit and the processor configured to cause the display control device to:
detect an obstacle around the vehicle based on a sensing result of a surrounding monitoring sensor that is configured to monitor a surrounding area of the vehicle;
predict a trajectory of the vehicle;
generate a bird's-eye view image which shows the vehicle and the surrounding area of the vehicle from above, using a captured image from a surrounding monitoring camera that is configured to capture the surrounding area of the vehicle;
display at least a part of the generated bird's-eye view image on a screen of a display device; and
offset a range of the bird's-eye view image to be displayed on the screen such that a displayed range of the surrounding area with respect to the vehicle changes according to the predicted trajectory and a position of the obstacle.

2. The display control device according to claim 1, wherein
the controller is configured to:
offset the range of the bird's-eye view image to be displayed on the screen in a forward direction along the predicted trajectory; and
set an offset amount of the range in the forward direction to a smaller value when the detected obstacle is within a predetermined distance from the predicted trajectory, as compared to a value when the obstacle is outside the predetermined distance from the predicted trajectory.

3. The display control device according to claim 1, wherein
the controller is configured to enable or disable offsetting of the range of the bird's-eye view image to be displayed on the screen, based on a selective input received from an occupant of the vehicle through a user input device.

4. The display control device according to claim 1, wherein
the controller is configured to superimpose an image indicative of the predicted trajectory on the at least a part of the bird's-eye view image.

5. The display control device according to claim 1, wherein
the controller is configured to offset the range of the bird's-eye view image to be displayed on the screen such that at least a part of the vehicle is included within the range.

6. A display control method that is used in a vehicle and performed by at least one of a circuit or a processor, the display control method comprising:
detecting an obstacle around the vehicle based on a sensing result of a surrounding monitoring sensor that is configured to monitor a surrounding area of the vehicle;
predicting a trajectory of the vehicle;
generating a bird's-eye view image which shows the vehicle and the surrounding area of the vehicle from above, using a captured image of a surrounding monitoring camera that is configured to capture the surrounding area of the vehicle; and
displaying at least a part of the generated bird's-eye view image on a screen of a display device, wherein
the displaying of the at least a part of the bird's-eye view image includes offsetting a range of the bird's-eye view image to be displayed on the screen such that a displayed range of the surrounding area with respect to the vehicle changes according to the predicted trajectory and a position of the obstacle.

7. A display control device to be used in a vehicle, the display control device comprising:
an obstacle detecting unit configured to detect an obstacle around the vehicle based on a sensing result of a surrounding monitoring sensor that is configured to monitor a surrounding area of the vehicle;
a predicted trajectory specifying unit configured to predict a trajectory of the vehicle;
a bird's-eye view image generating unit configured to generate a bird's-eye view image which shows the vehicle and the surrounding area of the vehicle from above, using a captured image of a surrounding monitoring camera that is configured to capture the surrounding area of the vehicle; and
a display control unit configured to:
display at least a part of the bird's-eye view image generated by the bird's-eye view image generating unit on a screen of a display device; and
offset a range of the bird's-eye view image to be displayed on the screen such that a displayed range of the surrounding area with respect to the vehicle changes according to the predicted trajectory and a position of the obstacle.
